(19) United States
(12) Patent Application Publication
(10) Pub. No.: US 2007/0176870 A1
(43) Pub. Date: Aug. 2, 2007

(54) Display apparatus and method for adjusting a display apparatus

(75) Inventors: Hsiang-Jui Hung, Taipei City (JP); Sun-Chen Yang, Taipei City (JP); Yun-Jiun You, Taipei City (TW); Chun-San Lin, Taipei City (JP); Han-Hsun Chen, Taipei City (JP)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/698,117

(22) Filed: Jan. 26, 2007

(30) Foreign Application Priority Data
Jan. 27, 2006 (TW) 095103546

(51) Int. Cl. G09G 3/36

(52) U.S. Cl. 345/88

(57) ABSTRACT

A display apparatus outputs a video frame according to ambient brightness. The display apparatus includes an ambient sensor for sensing the ambient brightness of the display apparatus to generate an ambient brightness sensing signal; and a control circuit, coupled to the ambient sensor, for dynamically adjusting display characteristics of the video frame according to the ambient brightness sensing signal without adjusting a light source of the display apparatus. γ (gamma) curve characteristics of the display apparatus can be adjusted to change the display characteristics (brightness and color temperature) of the outputted video frame without causing any damage on the light source hardware (such as the cold cathode fluorescent lamp (CCFL)).

### BACKGROUND OF THE INVENTION

1. Field of the Invention

The present invention relates to a display apparatus and method for adjusting video frames, and more particularly, to a display apparatus and method capable of dynamically adjusting display characteristics of a video frame outputted by the display apparatus without adjusting a display light source of the display apparatus.

2. Description of the Prior Art

Currently, a liquid crystal display (LCD) apparatus or a plasma television has built-in γ (gamma) curve characteristics for adjusting output images so that a video frame displayed has the best picture quality. Hence, the γ curve characteristic changes according to hardware of different LCD apparatus or plasma televisions. When an LCD apparatus outputs a video frame corresponding to a display data onto a screen, if the video frame is displayed in order to match different environments and requirements, then under the restrictions of not changing the γ curve characteristics, a user is required to change brightness on the display apparatus repetitively.

Take the LCD apparatus as an example. A conventional method is known by adjusting brightness of a back light module within the display apparatus to adjust brightness of the video frame displayed on the display apparatus. Generally, some prior art display apparatus on the market will include an ambient sensor to control the brightness of the back light module so that display brightness of the display apparatus changes according to ambient brightness; in another words, the picture of the display will adjust accordingly if the brightness of the background is either too dark or too bright, therefore the user will not notice the picture on the display to be too bright or too dark due to changes in the ambient brightness.

However, a disadvantage in the above-mentioned method, if the light source of the back light module is implemented by utilizing a cold cathode fluorescent lamp (CCFL), the CCFL usually utilizes a burst mode or an analog mode for adjustment, wherein the range of light adjustment for the burst mode is the widest, and this method is most often used. However, the adjustment of light in the burst mode also exerts a certain amount of damage on the CCFL, therefore if the brightness of the back light module changes constantly with the ambient brightness, the lifespan of the back light module will be shortened. Thus, it is an important issue to maintain the lifespan of the back light module.

### SUMMARY OF THE INVENTION

Therefore, one of the objectives of the present invention is to provide a display apparatus and method capable of dynamically adjusting display characteristics of a video frame outputted by the display apparatus without adjusting a display light source of the display apparatus to solve the above-mentioned problem.

The claimed invention discloses a display apparatus that is capable of outputting a corresponding video frame according to ambient brightness. The display apparatus comprises: an ambient sensor for sensing the ambient brightness of the display apparatus to generate an ambient brightness sensing signal; and a control circuit coupled to the ambient sensor for dynamically adjusting display characteristics of the video frame according to the ambient brightness sensing signal without adjusting a display light source of the display apparatus.

The claimed invention further discloses a method of adjusting a display apparatus wherein the display apparatus outputs a corresponding video frame according to ambient brightness. The method comprises: sensing the ambient brightness of the display apparatus to generate an ambient brightness sensing signal; and dynamically adjusting display characteristics of the video frame according to the ambient brightness sensing signal without adjusting a display light source of the display apparatus.

One advantage of the display apparatus of the present invention is to adjust γ (gamma) curve characteristics of the display apparatus according to an ambient brightness sensing signal generated from an ambient sensor of the display apparatus without adjusting a display light source of the display apparatus, hence adjusting γ (gamma) curve characteristics of the display apparatus can change the display characteristics (brightness and color temperature) of the outputted video frame without causing damage on the display light source hardware (such as the cold cathode fluorescent lamp (CCFL)).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a functional block diagram of a display apparatus according to an embodiment of the present invention.

FIG. 2 illustrates a flowchart of a method of adjusting a display apparatus according to an embodiment of the present invention.

### DETAILED DESCRIPTION

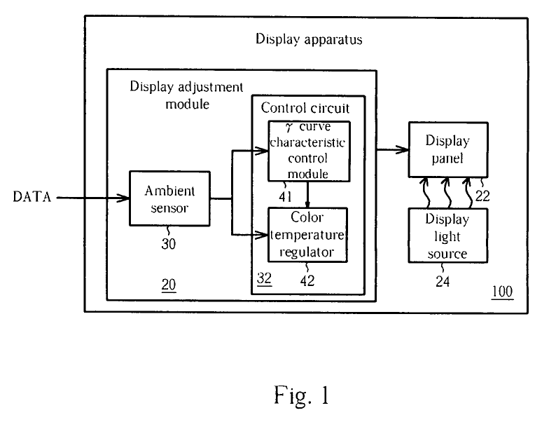

Please refer to FIG. 1. FIG. 1 illustrates a functional block diagram of a display apparatus 100 according to an embodiment of the present invention. The display apparatus 100 includes a display adjustment module 20, a display panel 22, and a display light source 24. The display apparatus 100 outputs a corresponding video frame on the display panel 22 according to a display data DATA. Furthermore, the display light source 24 is utilized for providing a uniform and bright light source for the display panel 22. In this embodiment, the display apparatus 100 can be a liquid crystal display (LCD) monitor, the display panel 22 can be an LCD panel, and the display light source 24 can be a back light module, however the present invention is not limited to the above-mentioned components. The display panel 22 and the display light source 24 can be conventional components, thus the operation and component composition will not be further mentioned for the sake of brevity.

In this embodiment, the display adjustment module 20 includes an ambient sensor 30 and a control circuit 32. The ambient sensor 30 is utilized for sensing ambient brightness of the display apparatus 100 to generate an ambient brightness sensing signal. The control circuit 32 is coupled to the ambient sensor 30 for adjusting display characteristics of the video frame according to the ambient brightness sensing signal without adjusting the display light source 24. As illustrated in FIG. 1, the control circuit 32 includes a γ (gamma) curve characteristic control module 41 and a color temperature regulator 42. The γ curve characteristic control module 41 is coupled to the ambient sensor 30, and the color temperature regulator 42 is then coupled to the ambient sensor 30 and the γ curve characteristic control module 41. The functions of γ curve characteristic control module 41 and the color temperature regulator 42 will be explained later. First, in this embodiment, the display adjustment module 20 is installed within the display apparatus 100, however the present invention is not limited to the above-mentioned configuration; in other words, in another embodiment of the present invention, the display adjustment module 20 can also be installed outside the display apparatus 100. These alternative designs fall in the scope of the present invention.

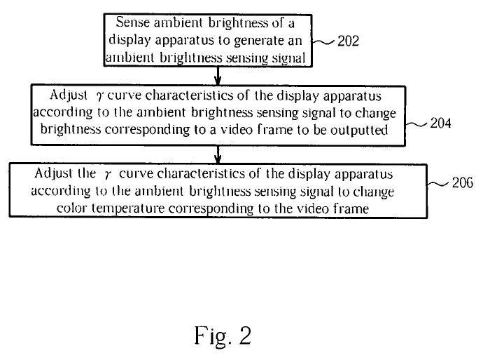

Please refer to FIG. 1 in conjunction with FIG. 2. FIG. 2 illustrates a flowchart of a method of adjusting a display apparatus according to an embodiment of the present invention. The adjustment of the display apparatus 100 is described in the following steps:
Step 202: The ambient sensor 30 senses the ambient brightness of the display apparatus 100 to generate an ambient brightness sensing signal;
Step 204: The γ curve characteristic control module 41 adjusts γ curve characteristics of the display apparatus 100 according to the ambient brightness sensing signal to change brightness corresponding to a video frame to be outputted; and
Step 206: The color temperature regulator 42 further adjusts the γ curve characteristics of the display apparatus 100 according to the ambient brightness sensing signal to change color temperature corresponding to the video frame.

As illustrated in the above steps, when the display apparatus 100 outputs a corresponding video frame according to a display data DATA, the following steps 202 to 206 are executed sequentially. Lastly, the display apparatus 100 outputs the adjusted video frame where the γ curve characteristic of display apparatus 100 includes a plurality of the γ curves corresponding to three RGB colors, therefore in step 204, the γ curve characteristic control module 41 adjusts a γ curve of the plurality of γ curves according to the ambient brightness sensing signal to change brightness corresponding to the video frame. And in step 206, the γ curve characteristic control module 41 adjusts a γ curve of the plurality of γ curves to change color temperature corresponding to the video frame. For example, if the ambient brightness is slightly dimmer, then the γ curve characteristic control module 41 will lower the color temperature of the video frame according to the detected ambient brightness sensing signal, and the video frame will be adjusted to show an image with slightly more yellow, thus when the video frame is displayed, the audience will not feel irritated by the brightness of the display; if the ambient brightness is slightly brighter, then the γ curve characteristic control module 41 will rise the color temperature of the video frame according to the detected ambient brightness sensing signal, and the video frame will be adjusted to show an image with slightly more blue. The detailed description of adjusting the display apparatus 100 to change the brightness or color temperature of the video frame is well known to those skilled in the art, therefore, it will not be reiterated.

Furthermore, in another embodiment of the present invention, the control circuit 32 can only include a γ curve characteristic control module 41 that is coupled to the ambient sensor 30, in other words, the control circuit 32 does not include a color temperature controller 42. Therefore when the display apparatus 100 outputs a video frame, at this time the γ curve characteristic control module 41 can adjust γ curve characteristics of the video frame according to an ambient brightness sensing signal without adjusting the display light source 24 to change the brightness corresponding to the video frame. The same objective of adjusting the display characteristics of the video frame is achieved through the assistance of the γ curve characteristic control module 41 even though the aforementioned color temperature regulator 42 is not implemented to change the color temperature corresponding to the video frame.

Furthermore, in another embodiment, the control circuit 32 can only include a color temperature regulator 42 that is coupled to the ambient sensor 30, in other words, the control circuit 32 does not include the γ curve characteristic control module 41, therefore when the display 100 outputs a video frame, at this time the color temperature regulator 42 can adjust γ curve characteristics of the display apparatus 100 according to an ambient brightness sensing signal without adjusting the display light source 24 to change the color temperature corresponding to the video frame. The same objective of adjusting the display characteristics of the video frame is achieved through the assistance of the color temperature regulator 42 even though the aforementioned γ curve characteristic control module 41 is not implemented to change the brightness corresponding to the video frame.

One advantage of the display apparatus of the present invention is to adjust γ (gamma) curve characteristics of the display apparatus according to an ambient brightness sensing signal without adjusting a display light source of the display apparatus, hence γ (gamma) curve characteristics of the display apparatus can be adjusted to change the display characteristics (e.g., brightness and color temperature) of the outputted video frame without causing any damage on the display light source hardware (such as the cold cathode fluorescent lamp (CCFL)).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display apparatus capable of outputting a corresponding video frame according to ambient brightness, the display apparatus comprising:
an ambient sensor for sensing the ambient brightness of the display apparatus to generate an ambient brightness sensing signal; and
a control circuit, coupled to the ambient sensor, for dynamically adjusting display characteristics of the video frame according to the ambient brightness sensing signal without adjusting a display light source of the display apparatus.

2. The display apparatus of claim 1 wherein the control circuit comprises:
a γ (gamma) curve characteristic control module, coupled to the ambient sensor, for adjusting γ curve characteristics of the display apparatus according to the ambient brightness sensing signal to change brightness corresponding to the video frame.

3. The display apparatus of claim 2 wherein the γ curve characteristic comprises a plurality of γ curves corresponding to three RGB colors, and the γ curve characteristic control module adjusts at least one γ curve of the plurality of γ curves to change the brightness corresponding to the video frame.

4. The display apparatus of claim 2 wherein the control circuit comprises:
a color temperature regulator, coupled to the ambient sensor and the γ curve characteristic control module, for further adjusting the γ curve characteristics according to the ambient brightness sensing signal to change a color temperature corresponding to the video frame.

5. The display apparatus of claim 4 wherein the γ curve characteristic comprises a plurality of γ curves corresponding to three RGB colors, and the γ curve characteristic control module adjusts at least one γ curve of the plurality of γ curves to change the color temperature corresponding to the video frame.

6. The display apparatus of claim 1 wherein the control circuit comprises:
a color temperature regulator, coupled to the ambient sensor, for adjusting γ curve characteristics of the display apparatus according to the ambient brightness sensing signal to change a color temperature corresponding to the video frame.

7. The display apparatus of claim 6 wherein the γ curve characteristic comprises a plurality of γ curves corresponding to three RGB colors, and the γ curve characteristic control module adjusts at least one γ curve of the plurality of γ curves to change the color temperature corresponding to the video frame.

8. The display apparatus of claim 1 is a liquid crystal display (LCD) monitor or a plasma television.

9. A method of adjusting a display apparatus, the display apparatus outputting a corresponding video frame according to ambient brightness, the method comprising:
sensing the ambient brightness of the display apparatus to generate an ambient brightness sensing signal; and
dynamically adjusting display characteristics of the video frame according to the ambient brightness sensing signal without adjusting a display light source of the display apparatus.

10. The method of claim 9 wherein the step of dynamically adjusting display characteristics of the video frame comprises:
adjusting a γ (gamma) curve characteristic of the display apparatus according to the ambient brightness sensing signal to change brightness corresponding to the video frame.

11. The method of claim 10 wherein the γ curve characteristic comprises a plurality of γ curves corresponding to three RGB colors, and the step of dynamically adjusting display characteristics of the video frame comprises:
adjusting at least one γ curve of the plurality of γ curves to change the brightness corresponding to the video frame.

12. The method of claim 9 wherein the step of dynamically adjusting display characteristics of the video frame comprises:
adjusting the γ curve characteristic of the display apparatus according to the ambient brightness sensing signal to change a color temperature according to the video frame.

13. The method of claim 12 wherein the γ curve characteristic comprises a plurality of γ curves corresponding to three RGB colors, and the step of dynamically adjusting display characteristics of the video frame comprises:
adjusting at least one γ curve of the plurality of γ curves to change the color temperature corresponding to the video frame.

14. The method of claim 9 wherein the display apparatus is a liquid crystal display (LCD) monitor or a plasma television.
